(19) United States
(12) Patent Application Publication
(10) Pub. No.: US 2020/0379227 A1
(43) Pub. Date: Dec. 3, 2020

(54) Method For Analyzing Fluorescent Particles in an Immunoassay

(71) Applicant: Charted Scientific, Inc., Austin, TX (US)

(72) Inventor: Edward Calvin, Austin, TX (US)

(73) Assignee: Charted Scientific, Inc., Austin, TX (US)

(21) Appl. No.: 16/942,219

(22) Filed: Jul. 29, 2020

Related U.S. Application Data
(63) Continuation-in-part of application No. 16/545,788, filed on Aug. 20, 2019.
Application No. 16/545,788 is a continuation-in-part of application No. 16/049,727, filed on Jul. 30, 2018, now Pat. No. 10,585,028.
(60) Provisional application No. 62/883,715, filed on Aug. 7, 2019.
(60) Provisional application No. 62/726,771, filed on Sep. 4, 2018.
(60) Provisional application No. 62/734,607, filed on Sep. 21, 2018.
(60) Provisional application No. 62/575,207, filed on Oct. 20, 2017.

(51) Int. Cl. G02B 21/00; G02B 21/36; G01N 21/64; G01N 15/14

(52) U.S. Cl. CPC G02B 21/0076; G02B 21/0032; G01N 15/1434; G02B 21/361; G01N 21/6428; G02B 21/006

(57) ABSTRACT

A method of making sensitive measurements of quantity of target analytes dissolved in liquid and attached to microsphere particles wherein the analyte coated particles are labeled with a fluorescent marker. The solution is placed in a light transparent container having a planar bottom and the particles allowed to settle. Illuminating a sample with a light source and creating a camera image. Evaluating the image for presence of particles within the sample and focus sharpness. Repositioning an objective lens or sample as required. Illuminating a portion of one particle within the sample with a light source having a specified wavelength and measuring the scattered light and emitted fluorescent light utilizing a confocal apparatus with at least one photodetector having specified photosensitive characteristics. Measurement of light characteristics includes laser scanning conformal cytometer. The method includes using a mathematical function derived standard curve to infer the concentration of the analyte.

### RELATED APPLICATIONS

This application claims benefit of and priority to the following pending applications or patents. The contents of these applications are incorporated herein by reference in their entirety. This Application is a Continuation In Part of application Ser. No. 16/545,788 entitled Method and Apparatus of Filtering Light Using a Spectrometer Enhanced with Additional Spectral Filters with Optical Analysis of Fluorescence and Scattered Light from Particles Suspended in a Liquid Medium Using Confocal and Non Confocal Illumination and Imaging filed Aug. 20, 2019 (CS-06); application Ser. No. 16/545,788 claims priority to provisional Application Ser. No. 62/726,771 entitled Novel Method for Optical Analysis of Fluorescence and Scattered Light from Particles Suspended in a Liquid Medium Using Confocal and Non-Confocal Illumination and Imaging filed Sept. 4, 2018 (CS-03); provisional Application Ser. No. 62/734,607 entitled Novel Method of Filtering Light Using a Spectrometer Enhanced with Additional Spectral Filters and which Uses an Array of Independent Photodetectors to Measure the Signal for Each Fluorescence or Scattered Light Channel filed Sep. 21, 2018 (CS-04); and provisional Application No. 62/883,715 entitled Method for Analyzing Fluorescent Particles in an Immunoassay file Aug. 7, 2019 (CS-05). Application Ser. No. 16/545,788 is also a Continuation in Part of application Ser. No. 16/049,727 (now U.S. Pat. No. 10,585,028) entitled Method and Apparatus for Optical Analysis and filed Jul. 30, 2018 (CS-01). Application Ser. No. 16/049,727 also claims priority to provisional Application Ser. No. 62/575,207 entitled Method and Apparatus for Optical Analysis and filed Oct. 20, 2017.

### FIELD OF USE

Assaying biological content of samples using coated microspheres with scanning cytometry.

### BACKGROUND OF THE INVENTION

A method of assaying biological content of a sample, termed here “binding assays”, uses microspheres made of polystyrene or other materials to capture and detect proteins, nucleic acid sequences, exosomes, or other biologically active molecules in a sample. Instead of measuring properties of individual cells, the microspheres are used to detect the presence or absence of biologically active molecules in the liquid sample. Capture molecules such as antibodies or nucleic acid sequences are attached to the outer surface of the microspheres, which then “capture” the target biologically active molecule. The presence of the target molecule in the sample may then be indicated using fluorescent labels which also bind to the target analyte but which bind to a different epitope on the analyte, so that the microspheres indicate the presence and quantity of the analyte in the sample by the degree to which material bound to the surface of the microsphere fluoresces. Microsphere assays are able to identify proteins, exosomes, man-made compounds such as drugs of abuse, specific nucleic acid sequences, or other biologically important molecules that may be present in the sample.

In order to accurately determine the concentration of the analyte within a sample using a binding assay as described above, the user typically first derives a standard curve relating the average fluorescence of particles in the sample to concentration of the analyte within the sample. This standard curve is derived by first preparing a number of standard reagents each containing the analyte of interest at a different concentration. The range of analyte concentrations in the standard reagents typically spans at least the total range of concentrations expected to be observed in an actual test sample. The binding assay as described above is performed using each of the standard reagents as a sample, and the resulting fluorescence corresponding to each analyte concentration is observed. A mathematical formula such as a polynomial is calculated to provide a mathematical model of the relationship between fluorescence and analyte concentration with the least error over the range of expected concentration (e.g. least squares curve fitting of a fourth order polynomial). Then, the measured fluorescence for a test sample with unknown analyte concentration is compared to the mathematical model to determine the measured analyte concentration.

In order to perform a binding assay and use its results to measure analyte concentration, a means of measuring the fluorescence of particles in the sample is needed. Flow cytometry and scanning cytometry are two such means.

Flow cytometry is a technique that uses specially designed optically clear channels to present the particles (e.g., cells or microspheres) in the sample one at a time to an optical system for measurement. The particles are typically illuminated by one or more focused lasers that illuminate only one particle at a time. The illumination may also be performed with other devices such as light emitting diodes (LEDs), arc lamps, or other light sources.

Flow cytometry is an efficient means of evaluating a large number of particles in a sample since the time to measure each individual particle is on the order of a few microseconds. The properties that are typically recorded for each particle include forward scattered light, side scattered light, back-scattered light, and one or more colors of fluorescence used to identify the previously referenced fluorescent labels. A “color” of fluorescence means a portion of the electromagnetic spectrum of light, such as the range of light having wavelengths between 500 nm and 530 nm. A flow cytometer might use one, two, or more lasers to collect the desired number of measurements for each particle in the sample.

Flow cytometry suffers a number of drawbacks when used as part of a method to assay liquid samples. One drawback of flow cytometry results from measuring particles sequentially. In order to measure a large number of particles sequentially in a short period of time, the time allowed to measure each individual particle is also short. A second drawback results from the method of illumination typically employed in flow cytometers. In order to provide highly uniform illumination to each particle, whose position within the optically clear channel may vary from particle to particle, a field of illumination substantially larger than the particle is used. Typically, an illumination field ten times the diameter of each particle or greater is used to illuminate each particle such that the illumination received by each particle only varies by a few percent from one particle to the next. Consequently, flow cytometers are only able to use a small percentage of the total illumination to analyze each particle. Because the illumination source is many times brighter than what is needed to illuminate a particle (between 10× and 100× brighter than the amount of light that actually illuminates the particle at any given time), the amount of stray light in the optical system is also much higher than desirable. Excess stray light interferes with the flow cytometer's ability to detect very weakly fluorescent particles, thereby degrading the sensitivity of the measurement.

Scanning cytometry, or laser-scanning cytometry, uses a microscope equipped with an optical scanning system to analyze and measure a number of cells or microspheres presented, for example, on a microscope slide for analysis. The samples are typically static; that is to say that particles being analyzed are spread out over a flat surface while being analyzed, and the optical system scans across the surface to evaluate the individual particles. Alternately, the slide holding the particles may be translated using a motorized stage beneath a fixed optical analysis system. Like a flow cytometer, a scanning cytometer is able to measure multiple fluorescence and light-scattering properties simultaneously.

Scanning cytometers address the illumination issues of flow cytometers by only illuminating the particle being analyzed with a focused light source (typically a laser). Through proper choice of illumination source and lenses, the illumination delivered to each particle may be as small as or smaller than the particle. These instruments can use lower power illumination sources compared to flow cytometers and have substantially less stray light than flow cytometers.

Whereas a flow cytometer is able to measure an arbitrarily large number of particles for any sample, a scanning cytometer is typically limited by the area the machine can analyze (i.e., the field of view of the microscope). In order to scan a larger portion of the surface on which the particles are held, thereby increasing the number of particles that may be measured, scanning cytometers use precise translation stages that can move the surface through the field of view. This method of scanning increases the cost of the equipment and involves a long analysis time during which the scanning occurs.

Scanning cytometers typically use an epi-fluorescent microscope as the means of delivering light to the sample and collecting light emitted by the sample. While this configuration eliminates the problem of illuminating an excess area surrounding each particle, it still illuminates excess material in the sample above and/or below the particle of interest. To the extent that other particles or other unbound fluorescent material is present in the sample at different depths than the particle of interest, it will interfere with measurement of weak fluorescent signals from the particle and thereby reduce the sensitivity of the measurement.

Whereas flow cytometers are designed to measure particles suspended in a liquid sample, scanning cytometers are generally limited to measuring particles that have been immobilized on a flat surface. Immobilization can be achieved by placing a coverslip over the sample or by fixing the particles in the sample to a planar surface (such as in pending patent application US20140065637A1 of Gregory L. Kirk et al and assigned to KLA-Tencor Corporation). Both of these methods suffer the drawback of adding labor and time to sample preparation.

A method to enable assays of liquid samples using rapid, highly sensitive analysis of fluorescent particles within the samples would be useful and valuable.

### SUMMARY OF THE DISCLOSURE

Disclosed herein is a method for making sensitive measurements of the quantity of one or more target analytes (such as a specific protein) that is dissolved or suspended in a liquid sample. The term “analyte” used in this method means a specific chemical compound that may be present in a biological sample, including without limitation proteins, nucleic acid sequences, enzymes, and peptides.

The method involves:

Capturing the target biomarker present in a sample solution on the surface of microspheres that have been coated with a capture molecule (such as an antibody) that selectively binds to the biomarker;

Labeling the target biomarker that has been bound to microspheres with a second, fluorescently labeled capture molecule (such as an antibody) that is added to the sample solution;

Causing the microspheres in the sample solution to settle onto a planar, optically clear surface;

Using a laser-scanning confocal cytometer to measure the fluorescence and other optical properties of particles in the sample such as absorption at a particular wavelength; and

Using a mathematical function termed a “standard curve” (as described above) to infer the concentration of the biomarker in the original sample solution based on the average fluorescence of the microspheres in the sample that are measured.

### BRIEF DESCRIPTION OF FIGURES

The accompanying drawings, which are incorporated in and constitute a part of the specification, may illustrate preferred embodiments of the disclosure. These drawings, together with the general description of the disclosure given above and the detailed description of the preferred embodiments given below, serve to explain the principles of the disclosure.

FIGS. 1A and 1B illustrate steps of one embodiment of the method of performing this disclosure.

FIG. 2 illustrates one embodiment of a configuration of devices that may be utilized to perform the method.

FIG. 3 illustrates an embodiment of devices used to scan the samples subject of this disclosure.

FIG. 4 illustrates another embodiment including a plurality of lasers and fluorescence detectors.

FIG. 5 illustrates another embodiment for scanning the samples subject of the disclosure including multiple spectrum detectors and spectral filters.

FIG. 6 illustrates a listing of particle parameters that may be detected in the configuration of FIG. 3.

FIG. 7A illustrates a exemplary table of varying biomarker concentrations with exemplary detected values of fluorescence intensity.

FIG. 7B illustrates an algorithm of a least-squares analysis to fit the equation complementary to the data from FIG. 7a.

FIG. 7C illustrates a computed graph of the values listed in FIG. 7a

FIGS. 8A and 8B illustrate another embodiment of the method of performing the disclosure wherein the sample contains multiple target analytes.

FIG. 9 illustrates the listing of particle parameters that may be detected in the method described in FIG. 8.

FIG. 10 illustrates a grid of fluorescent intensity detected among two wavelengths.

FIGS. 11A and 11B illustrate another embodiment of the disclosure wherein the sample contains multiple groups of microspheres.

FIG. 12 illustrates another embodiment of a grid of fluorescent intensity.

### DETAILED DESCRIPTION OF DISCLOSURE

It will be appreciated that not all embodiments of the disclosure can be disclosed within the scope of this document and that additional embodiments of the disclosure will become apparent to persons skilled in the technology after reading this disclosure. These additional embodiments are claimed within the scope of this disclosure.

The contents of the section entitled Summary of Disclosure are incorporated into the

Detailed Description of the Disclosure herein.

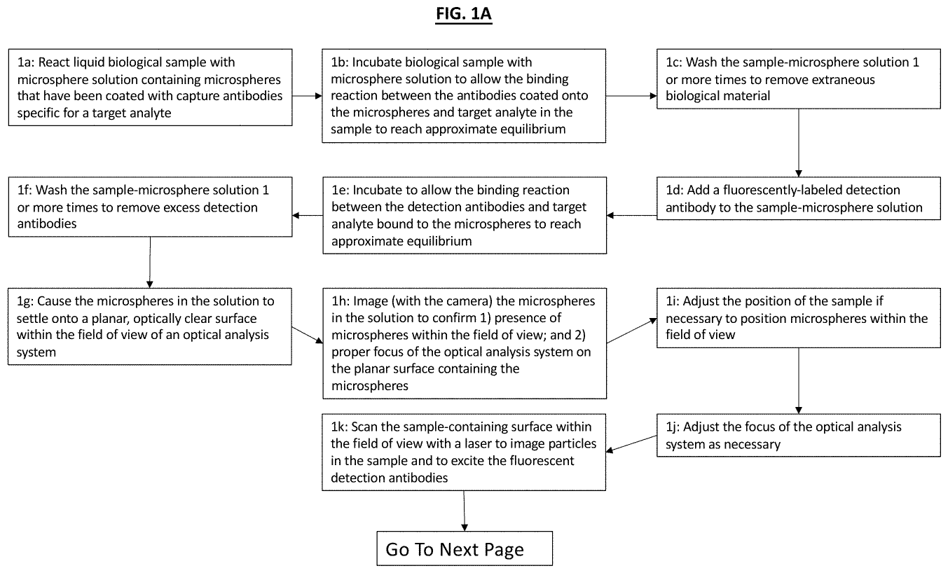

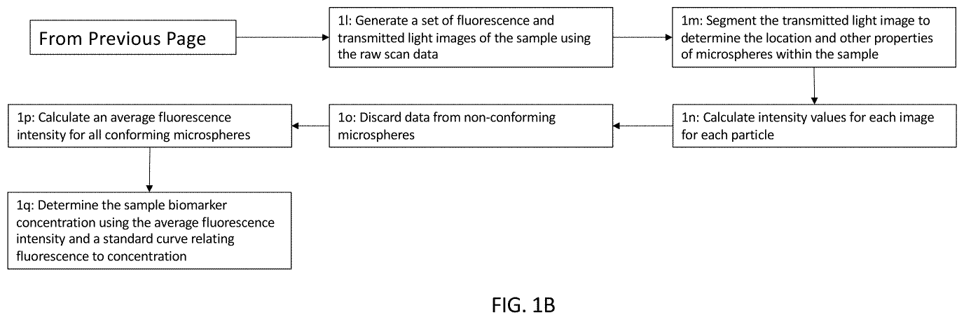

FIG. 1 illustrates one embodiment of this method.

[1a] A quantity of liquid sample that may contain a target analyte is added to a solution containing microspheres suspended in a buffer solution such as phosphate buffered saline. The microspheres are coated with a molecule (such as an antibody) that selectively binds the target analyte and has a very low affinity to bind other molecules that may also exist in the sample.

[1b] The sample and microsphere solution are incubated together for a sufficient amount of time to allow the majority of the reaction between the microsphere-bound capture molecule and the target analyte to take place, such as one hour.

[1c] The vessel containing sample and microspheres may be washed one or more times, where the liquid is removed and replaced with a clean buffer solution while the microspheres are retained in the vessel. By washing the vessel in this manner, molecules present in the sample other than the target analyte may be removed so that they do not interfere with subsequent steps in this assay method. It will be understood that there are multiple ways to remove the liquid from the vessel while retaining the microspheres, such as centrifugation. As part of the wash step, the microspheres with target analyte captured on the surface are resuspended in clean buffer solution.

[1d] A fluorescently-labeled detection molecule (such as an antibody) is added to the vessel. The detection molecule selectively binds to the target analyte such that the detection antibody has a low likelihood of binding to molecules other than the target analyte that may have adhered to the microspheres. It will be understood that other steps may be taken to prevent such non-specific binding, such as introducing additional reagents specifically for this purpose. The fluorescent label attached to the detection antibody is a molecule that can be excited by light at a certain frequency and in response emits light at a lower frequency.

[1e] The microspheres with the target analyte bound to the surface and the fluorescently-labeled detection molecule are incubated together for a sufficient amount of time to allow the majority of the reaction between the target analyte and the detection molecule to take place, such as one hour.

[1f] The vessel containing the microspheres and the detection molecule may be washed one or more times, where the liquid is removed and replaced with a clean buffer solution while the microspheres are retained in the vessel. By washing the vessel in this manner, excess unbound fluorescent detection molecule may be removed. It will be understood that unbound fluorescent molecules in the sample, such as excess detection molecules, increase the background fluorescent signal level and thereby decrease the sensitivity with which the fluorescence of each microsphere may be measured. As in the previous wash step, the microspheres with target analyte and fluorescent-labeled detection molecules captured on the surface are resuspended in clean buffer solution.

[1g] The microspheres are caused to settle onto a planar surface for analysis. In a preferred embodiment, the reaction described above is carried out in a vessel with an optically clear, flat bottom and the microspheres used in the reaction are polystyrene material with a specific gravity of approximately 1.05 and a diameter of approximately Sum. By carefully controlling the volume of liquid in the vessel following the final wash step described above, the depth of the liquid in the vessel can be kept to a maximum of approximately 1 millimeter.

Under these conditions, substantially all of the microspheres will settle to the bottom of the vessel after a period of 20 minutes.

Additional embodiments of the method include use of microspheres with higher specific gravity such as silica and/or larger diameter to facilitate faster settling.

Yet another embodiment includes the use of microspheres containing a small amount of magnetic material so that the microspheres may be made to settle using an externally-applied magnetic field.

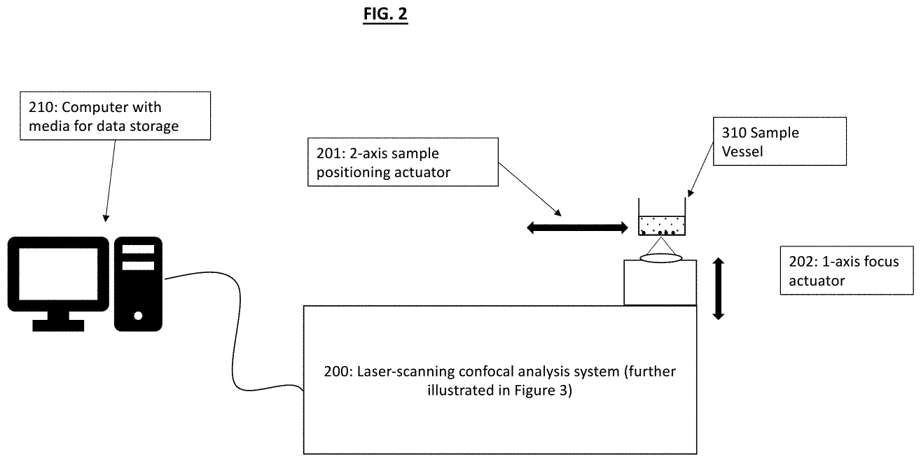

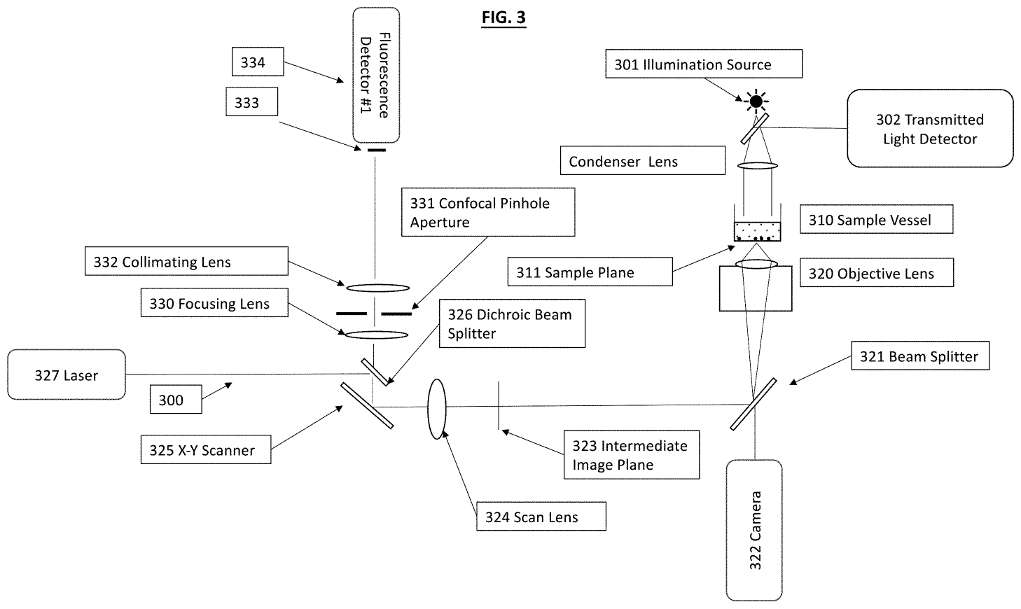

The vessel containing the microspheres which have settled onto the bottom surface is placed in an optical analysis system such as the laser-scanning confocal cytometer system illustrated in FIGS. 2 and 3.

FIG. 2 depicts the optical analysis system 200 shown in greater detail in FIG. 3, a liquid sample contained within a sample vessel 310, a motorized means of positioning the sample in two axes 201, a motorized means of adjusting the focus of the optical analysis system 202, and a computer with data storage and processing capabilities 210.

The optical analysis system includes an illumination source such as an LED that illuminates the entire sample 301, the objective lens of the laser-scanning confocal cytometer (320) and which is focused on the planar surface 311 occupied by the microspheres (termed here the “sample plane”), and an area detector such as a CCD or CMOS camera positioned in the image plane of the objective lens 322.

(1h) While illuminating the field of view of the objective lens 320 with the illumination source 301, an analysis is made of the contents of the field of view by obtaining an image of the sample in the field of view using the area detector 322 to determine 1) if microspheres are present in the field of view; and 2) if the microspheres in the field of view are adequately focused. If there are sufficient microspheres in the field of view and the system is in proper focus, the analysis proceeds.

It will be understood by a person skilled in the art that multiple methods exist for determining the focus quality of an image. One such method uses a measure of the variation in intensity between adjacent pixels in an image, or the variation of intensity among pixels in a small region of an image, and summing that variation over the entire image or over select regions of interest in the image. Regions of interest could be defined to include the microspheres and exclude regions that do not contain microspheres, thereby making the measure of focus sensitive to regions containing microspheres and insensitive to other objects that may be in the image such as debris or air bubbles and also insensitive to regions containing no discernible objects.

(1i) If the field of view does not contain sufficient microspheres, the sample vessel 310 may be repositioned to a location where more microspheres are visible.

(1j) If the microspheres in the field of view are out of focus, the objective lens 320 may be repositioned to achieve better focus. It will be understood that an alternative method of adjusting the focus would be to move the sample vessel 310 with respect to the objective lens 320. It will be appreciated that imaging or analysis at this step will facilitate that a subsequent image of the microspheres utilizing the laser 327 will be enhanced and time saved by avoiding unnecessary raster scanning, photo bleaching, or similar. If the image obtained in step 1(h) is adequate, the method can skip steps 1(i) and 1(j) and proceed directly to step 1(k).

(1k) The sample is raster-scanned by the laser-scanning confocal cytometer. Referring to a preferred embodiment as depicted in FIG. 3, a laser 327 provides the illumination for the confocal scanning system. The laser beam is reflected by the dichroic beamsplitter 326, which reflects light at the laser wavelength and transmits fluorescent light at longer wavelengths. The X-Y scanner 325 directs the laser beam 300 through a scan lens 324 and provides a means to scan the beam across the sample plane 311 in 2 axes. The scan lens 324 focuses the laser beam 300 to a small spot in the intermediate image plane 323 of the objective lens 320. A dichroic beam splitter 321 reflects the laser beam 300 into the objective lens 320, which re-focuses the beam 300 into a spot on the sample plane 311. By careful selection of the laser beam diameter and wavelength, the scan lens, and the objective lens, a laser spot in the plane of the sample can be obtained that is much smaller than the 5 μm diameter of the microspheres preferred for use in the sample.

It will be appreciated that an image of the sample may be obtained much more rapidly and with a lower level of illumination using the LED illumination source 301 and camera 322 described above compared to imaging the sample by raster-scanning with a laser. One benefit of this approach is speed; by avoiding unnecessary scans with the laser until the preliminary checks of the sample and focus have been made, time wasted on repeating scans is avoided. Another benefit is a reduction in photobleaching. Each scan of the sample with a laser results in exposure of the fluorescent label molecules to a high-intensity light source, causing degradation of those molecules.

After transecting the sample plane 311, the laser beam 300 is received by a transmitted light detector 302 positioned above the sample vessel 310 (the beam may be focused and directed by an appropriate combination of lenses, mirrors, and/or dichroic beam splitters first). Where the sample plane 311 contains no particles, the majority of the laser beam 300 will reach the transmitted light detector 302 and will generate a relatively large signal. Where the sample plane 311 contains a particle, a portion of the laser beam 300 will be absorbed or scattered and the resulting signal produced by the transmitted light detector 302 will be lower.

Some of the light incident on particles in the sample plane 311 will be absorbed by fluorescent molecules in the sample and will cause light at longer wavelengths to be emitted. Said fluorescent light will be emitted in a random direction and will result in fluorescent light emanating uniformly in all directions from the point where the laser beam 300 intersects the sample plane 311.

Fluorescent light from particles in the sample is collected by the objective lens 320 and directed by the beam splitter 321 towards the scan lens 324. The objective lens 320 forms an image of the sample on the intermediate image plane 323. The fluorescent light is then collimated by the scan lens 324 and directed towards the X-Y scanner 325, which de-scans the fluorescent light. The fluorescent light passes through the dichroic beam splitter 326 and is focused on the pinhole aperture 331 by the focusing lens 330. The pinhole aperture 331 permits focused light from the sample plane 311 to pass through, and rejects the majority of light originating from depths above or below the sample plane 311.

The collimating lens 332 focuses light exiting the pinhole aperture 331 into a substantially parallel beam of light which is directed towards the fluorescence detector 334. A bandpass filter 333 is placed in front of the detector 334 that restricts the range of wavelengths of fluorescent light allowed to reach the detector 334. In one embodiment, a bandpass filter 333 that passes light between 560 nm and 580 nm is placed in front of fluorescence detector 334.

It will be readily understood that bandpass filters with different pass bands may be chosen, and that additional fluorescence detectors may be used.

A benefit of this method is its ability to reject fluorescent light emanating from planes above or below the sample plane 311. Other methods such as flow cytometers and epi-fluorescent microscopy systems do not have this ability. Fluorescence from planes other than the sample plane 311 constitutes unwanted noise and limits the ability of a system to detect very weak fluorescence signals.

(1l) The result of raster-scanning the sample (FIG. 1, step 1k) is a set of two images of the sample. One image is derived from light measured by the Transmitted Light Detector 302 and the second image is derived from light measured by the fluorescence detector 334. The transmitted light image measures absorption and/or scattering of light at the wavelength of the laser 327 used for excitation of the sample. It will be appreciated that the transmitted light image reveals all particles in the sample of sufficient size and with a sufficiently different refractive index than the surrounding liquid to be resolved by the objective lens 320, without regard to the fluorescence of the particles.

(1m) The transmitted light image is segmented to identify particles in the image and to measure information such as size and shape of each particle. Those skilled in the art of image analysis will understand that a number of methods may be used to segment the image, including but not limited to a circular Hough transform, the watershed method, or thresholding. The output of the segmentation step is a list of particles identified in the image, X and Y coordinates of the centroid of each particle, a boundary of the pixels contained within the particle such as a bitmap, and may also include a size parameter such as the number of pixels contained within the boundary of the particle and/or a measure of shape such as ellipticity (a ratio of the major axis of the particle to the minor axis of the particle).

(1n) A transmitted light intensity value is calculated for each particle in the transmitted light image by calculating: 1) an estimate of the average intensity of the transmitted light image in the vicinity of the particle for pixels that are not within the boundary of that particle or of any other particle; 2) subtracting the average intensity value from the intensity value of each pixel contained within the boundary of the particle to obtained a background-subtracted intensity value for that pixel; 3) summing the background-subtracted intensity values for all pixels contained within the boundary of the particle; and 4) multiplying the pixel sum by −1 (because the intensity value of pixels within the particle is typically lower than pixels not contained within a particle in the transmitted light image).

For each particle, a fluorescence intensity value is obtained by calculating: 1) an estimate of the average intensity of the fluorescence image in the vicinity of the particle for pixels that are not part of that particle or of any other particle; 2) subtracting the average intensity value from the intensity value of each pixel contained within the boundary of the particle to obtained a background-subtracted intensity value for that pixel; and 3) summing the background-subtracted intensity values for all pixels contained within the boundary of the particle. The location of the particle and the boundary of the particle found from segmenting the transmitted light image are used for the calculation of each fluorescence intensity value.

A benefit of this method of analyzing particles, particularly with respect to other methods such as flow cytometry, is the increased amount of information about each particle (size, shape). A second benefit of this method is the ability to further analyze the sample image data at a later date, whereas flow cytometry typically generates data at rates too high to enable efficient storage and archiving of the raw data.

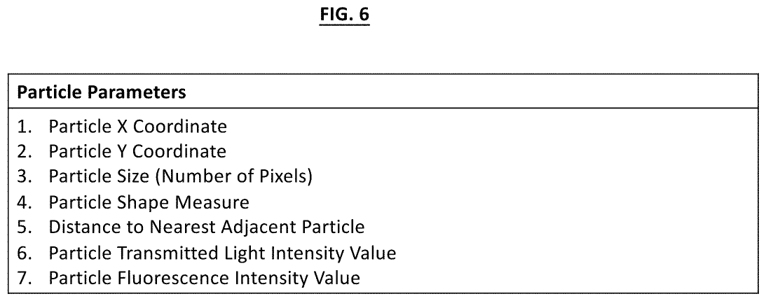

The result of the image analysis described above is a record of each particle containing all of the parameters listed in FIG. 6.

(1o) A subset of the parameters listed in FIG. 6 may be used to confirm the identity of particles that are likely to be microspheres and to further identify particles that are not likely to be microspheres. A subset of the particles which have been identified as microspheres may be created for subsequent analysis. For example, particles may be excluded from subsequent analysis if they are 1) too small; 2) too large; or 3) too close to adjacent particles.

(1p) A measure of the average fluorescence intensity for all the particles included in the subset of particles identified as microspheres is calculated, such as the median fluorescence intensity. The average fluorescence intensity is then used to calculate the target analyte concentration in the sample. This concentration is calculated using a mathematical relation between analyte concentration and average fluorescence intensity (known in the art as a standard curve).

A standard curve may be derived to relate the average measured fluorescent intensity of a population of microspheres prepared and analyzed according to this method to the concentration of the target analyte in a liquid sample.

The standard curve is derived by first performing the sample preparation and analysis described in this method with a number of samples containing different concentrations of the target analyte and then observing the measured average fluorescent intensity of the microspheres for each analyte concentration. FIG. 6a shows the resulting data for a series of 6 different concentrations of a hypothetical target analyte and the measured fluorescent intensity for each concentration.

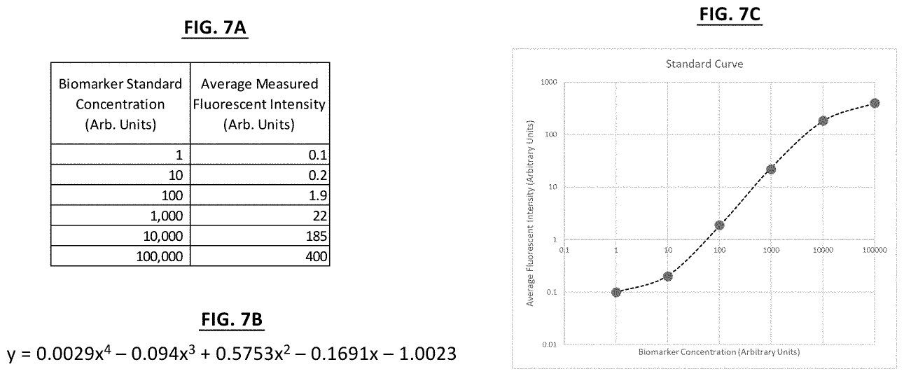

The data shown in FIG. 7a is used to derive a mathematical relationship between fluorescent intensity and analyte concentration. One such relationship could be a fourth-order polynomial equation. Using the least-squares method to fit the equation to the data from FIG. 7a results in the formula shown in FIG. 7b. FIG. 7c shows the observed data (circles) and the formula (dashed line).

(1q) A previously unknown biomarker concentration for the test sample can be determined by using the measured fluorescence intensity produced through this method to find the concentration along the standard curve that matches the observed fluorescence intensity.

Other methods such as flow cytometry require that the sample be aspirated from the vessel for analysis. A benefit of this method compared to alternate methods such as flow cytometry is the complete elimination of carryover between samples that are analyzed sequentially resulting from residual sample clinging to the aspiration mechanism. A second benefit of this method is the elimination of failure mechanisms resulting from clogs of the sample aspiration system or failure to aspirate sufficient sample for analysis.

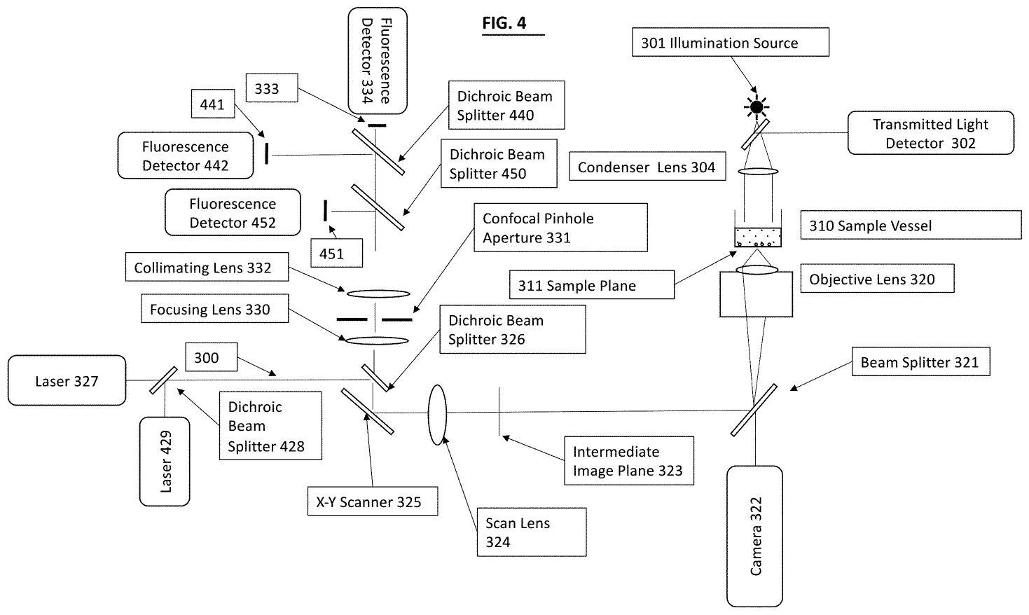

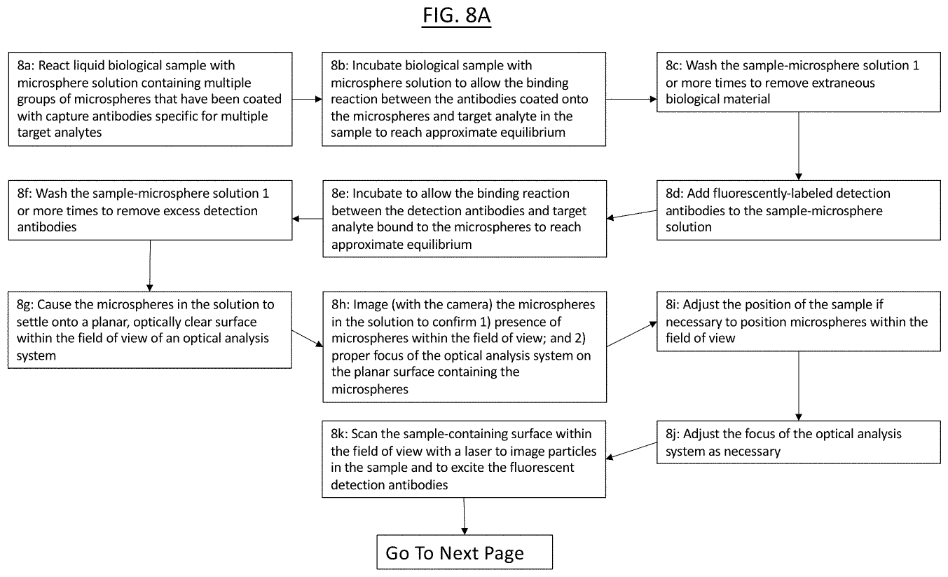

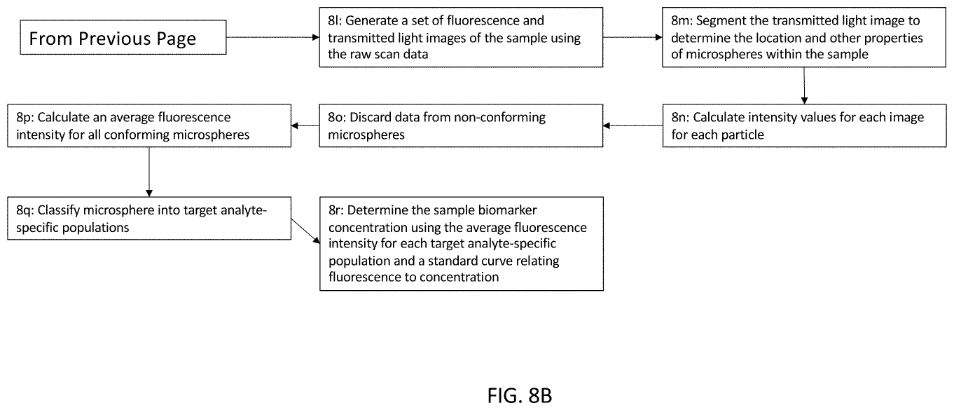

An additional embodiment of this method is illustrated in FIG. 4 utilizing two lasers 327 and 429 to raster-scan the sample and using three fluorescence detectors 334, 442, and 452 to measure fluorescent light from the sample. The addition of a second laser 429 and the two additional fluorescence detectors enables the simultaneous measurement of multiple analytes within each sample using this method, as is illustrated in FIG. 8 and as is described below.

In the embodiment illustrated in FIG. 4, a laser 327, which could have a wavelength of 488 nm or 532 nm, is used to excite the fluorescent label attached to the detection antibodies and which emits light that is detected by a fluorescent detector 334 in the wavelength range from 560 nm to 580 nm.

Dichroic beam splitter 450 reflects light with wavelengths longer than 700 nm to fluorescence detector 452. This detector measures fluorescent light emanating from fluorescent molecules within the microspheres which is excited by laser 429, which could have a wavelength of approximately 638 nm. A bandpass filter 451 placed in the path of the fluorescent light directed towards fluorescence detector 452 restricts light entering that detector to light that only has a wavelength longer than 700 nm.

Dichroic beam splitter 440 reflects light with wavelengths longer than 600 nm to fluorescence detector 442. This detector measures fluorescent light emanating from fluorescent molecules within the microspheres which is excited by laser 429. A bandpass filter 441 placed in the path of the fluorescent light directed towards fluorescence detector 442 restricts light entering that detector to light with a wavelength between 660 nm and 680 nm.

The addition of laser 429 and fluorescence detectors 442 and 452 enables the measurement of two or more fluorescent molecules that are excited by light at approximately 638 nm and that preferentially emit light either between 638 nm and 700 nm or at wavelengths greater than 700 nm. As will be explained in the discussion of FIG. 8, this embodiment enables the simultaneous detection of multiple target analytes within a single sample.

It will be readily understood that more than two lasers may be incorporated in the system, and that more than 3 fluorescence detectors may be incorporated in the system.

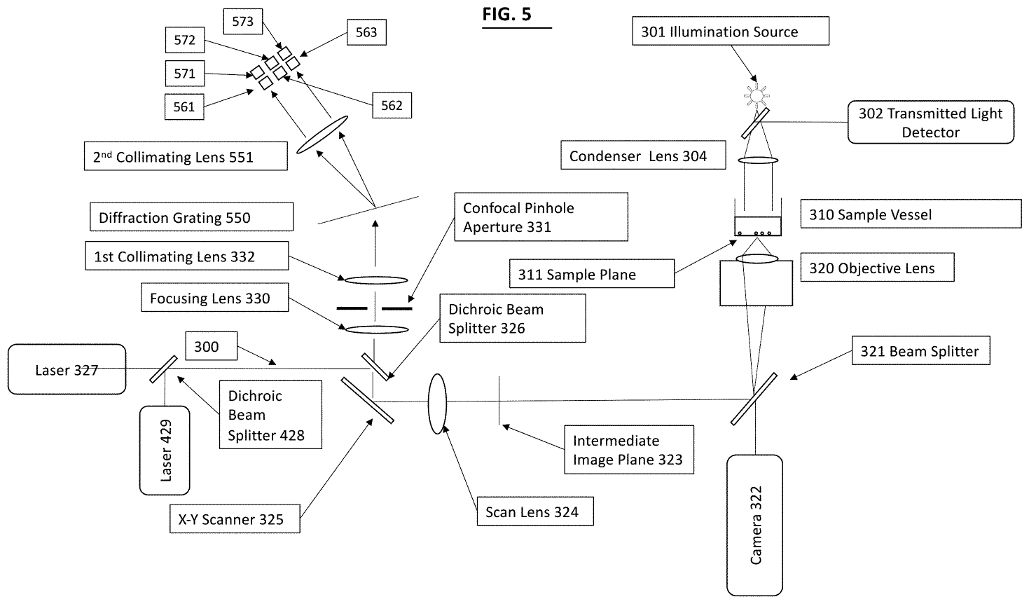

In another embodiment illustrated in FIG. 5, a dispersive element 550 (e.g. a diffraction grating) is used to separate the fluorescent light after it exits the pinhole aperture 331. After the pinhole aperture 331, the light is re-collimated by the 1^{st} collimating lens 332 and directed towards the diffraction grating 550. The diffraction grating 550 disperses the fluorescent light from the sample according to wavelength, so that light of shorter wavelengths is deflected a greater angle from the incident light beam than light of longer wavelength. In a preferred embodiment, a holographic diffraction grating is selected with line spacing designed to maximize transmission of light at 550 nm-600 nm for the −1 order.

Light from the diffraction grating (550) is imaged onto an array of fluorescence detectors (571, 572, and 573) by the 2^{nd} collimating lens 551. Each detector in the array is placed to receive light within a specified range of wavelengths. In one embodiment, detectors with a width of 3 mm are used. The diffraction grating 550 and collimating lens 551 are chosen such that fluorescent light with wavelengths ranging from 525 nm to 725 nm is dispersed over a width of 30 mm in the plane of the detectors. Fluorescence detector 571 is placed to receive light with wavelengths ranging from 560 nm to 580 nm, fluorescence detector 572 is placed to receive light ranging from 660 nm to 680 nm, and fluorescence detector 573 is placed to receive light with wavelengths ranging from 700 nm to 720 nm. It should be readily understood that fewer or more detectors could be used to collect light in fewer or more wavelength ranges, and that the detector size, diffraction grating, or collimating lens design could be changed to achieve greater or smaller ranges of wavelengths collected by each detector.

Individual bandpass filters 561, 562, and 563 may be placed in front of each detector in the array to enhance the blocking of out-of-band light reaching that detector. The bandpass filters may be individually optimized based on the range of wavelengths to be detected by the individual detectors. In comparison to prior art where the fluorescent light separated by a diffraction grating is directly measured by detectors, this invention provides the advantage of increased light separation performance. By combining the filtering capabilities of bandpass filters with the dispersion of the diffraction grating, better rejection of out-of-band light is possible than would be achievable using only bandpass filters or bandpass filters and dichroics.

The embodiment illustrated in FIG. 5 offers the same capabilities as the embodiment illustrated in FIG. 4, and which are incorporated in the method illustrated in FIG. 8, but provides additional benefits. One benefit of this invention is its simplicity compared to using dichroic beam splitters to separate the fluorescent light, in particular where many fluorescence detectors are used. Each dichroic employed in the system illustrated in FIG. 4 requires an adjustment mechanism in addition to the dichroic itself. Increasing the number of fluorescence detectors increases the cost, complexity, and alignment requirements in proportion to the number of detectors. In contrast, one dispersive element can be used to divide light among an arbitrarily large number of fluorescence detectors.

In some examples of prior art, a single detector with multiple channels (e.g. a multi-channel photomultiplier tube) is used to receive light dispersed from a diffraction grating. Another benefit of this invention is the ability to adjust the gain of each individual detector, which would not be possible with a multi-channel single detector. Yet another advantage of this invention is the ability to use different types of detectors in the detector array, where each detector is chosen based on the range of wavelengths and range of light levels expected to be received.

In other examples of prior art, a blocking filter is installed, either between the 1^{st} collimating lens and the diffraction grating or after the diffraction grating, to suppress light at the wavelength of the excitation sources (lasers). This invention offers greater flexibility and efficacy because the bandpass filter placed in front of each of the detectors may be optimized to reject not only light at the excitation wavelengths but also fluorescent light at any wavelength outside the intended wavelength range of that fluorescence detector.

It will be appreciated that this method could be used to test for multiple analytes simultaneously within a single sample.

FIG. 8 illustrates the modifications to the method illustrated previously in FIG. 1 that would be required to accomplish tests of multiple analytes simultaneously within the same sample.

(8a) A quantity of liquid sample that may contain multiple target analytes (for example, 4 different target analytes) is added to a solution containing multiple distinct populations of microspheres suspended in a buffer solution such as phosphate buffered saline. Each microsphere population is coated with a molecule (such as an antibody) that selectively binds to one target analyte and has a very low affinity to bind other molecules that may also exist in the sample, including the other target analytes.

In one embodiment, each of the microsphere populations can be distinguished from the other populations based on two additional colors of fluorescence (in addition to the color of fluorescence used to quantify the presence of target analyte). FIGS. 4 and 5 illustrate embodiments of laser-scanning confocal optical systems capable of measuring multiple colors of fluorescence to facilitate this embodiment of the invention.

(8b) The sample and microsphere solution are incubated together for a sufficient amount of time to allow the majority of the reaction between the microsphere-bound capture molecules and the target analytes to take place, such as one hour.

(8c) The vessel containing sample and microspheres may be washed one or more times, where the liquid is removed and replaced with a clean buffer solution while the microspheres are retained in the vessel. By washing the vessel in this manner, molecules present in the sample other than the target analytes may be removed so that they do not interfere with subsequent steps in this assay method. It will be understood that there are multiple ways to remove the liquid from the vessel while retaining the microspheres, such as centrifugation. As part of the wash step, the microspheres with target analytes captured on the surface are resuspended in clean buffer solution.

(8d) Fluorescently-labeled detection molecules (such as an antibodies) are added to the vessel. A different fluorescently-labeled antibody that selectively binds to each of the target analytes is added for each target analyte being assayed. The fluorescent label attached to the detection antibody is a molecule that can be excited by light at a certain frequency and in response emits light at a lower frequency. In this embodiment, the same fluorescent label may be used for each of the different target analytes.

(8e) The microspheres with the target analyte bound to the surface and the fluorescently-labeled detection molecule are incubated together for a sufficient amount of time to allow the majority of the reaction between the target analytes and the detection molecules to take place, such as one hour.

(8f) The vessel containing the microspheres and the detection molecules may be washed one or more times, where the liquid is removed and replaced with a clean buffer solution while the microspheres are retained in the vessel. By washing the vessel in this manner, excess unbound fluorescent detection molecules may be removed. It will be understood that unbound fluorescent molecules in the sample, such as excess detection molecules, increase the background fluorescent signal level and thereby decrease the sensitivity with which the fluorescence of each microsphere may be measured. As in the previous wash step, the microspheres with target analytes and fluorescent-labeled detection molecules captured on the surface are resuspended in clean buffer solution.

(8g) The microspheres are caused to settle onto a planar surface for analysis. In a preferred embodiment, the reaction described above is carried out in a vessel with an optically clear, flat bottom and the microspheres used in the reaction are polystyrene material with a specific gravity of approximately 1.05 and a diameter of approximately 5 μm. By carefully controlling the volume of liquid in the vessel following the final wash step described above, the depth of the liquid in the vessel can be kept to a maximum of approximately 1 millimeter. Under these conditions, substantially all of the microspheres will settle to the bottom of the vessel after a period of 20 minutes.

The vessel containing the microspheres which have settled onto the bottom surface is placed in an optical analysis system such as a laser-scanning confocal cytometer illustrated in FIG. 5.

The optical analysis system includes an illumination source such as an LED 301 which illuminates the entire sample simultaneously, an objective lens 320 which is focused on the sample plane 311, and an area detector such as a CCD or CMOS camera 322 positioned in the image plane of the objective lens 320.

(8h) While illuminating the field of view of the objective lens 320 with the illumination source 301, an analysis is made of the contents of the field of view by obtaining an image of the sample in the field of view using the camera 322 to determine 1) if microspheres are present in the field of view; and 2) if the microspheres in the field of view are adequately focused. If there are sufficient microspheres in the field of view and the system is in proper focus, the analysis proceeds. If there are sufficient microspheres, adequate focus, etc., the analysis may proceed directly to 8(k). As noted above, this can achieve a savings of time, result in better quality scanned images, and may also minimize photobleaching, etc.

(8i) lithe field of view does not contain sufficient microspheres, the sample vessel 310 may be repositioned to a location where more microspheres are visible.

(8j) If the microspheres in the field of view are out of focus, the objective lens 320 may be repositioned to achieve better focus. It will be understood that an alternative method of adjusting the focus would be to move the sample vessel 310 with respect to the objective lens 320.

(8k) The sample plane 311 is raster-scanned by the laser-scanning confocal cytometer.

In this embodiment the sample is scanned with a first laser 327 used for excitation of the fluorescent labels bound to the detection antibodies, which could be a wavelength of 488 nm or a wavelength of 532 nm, and then with a second laser 429 of a different wavelength, which could be approximately 638 nm and which is used to excite fluorescent molecules embedded within the microspheres.

(8l) The result of raster-scanning the sample (FIG. 8, step 8k) is a set of images of the sample. Each image pertains to one of: the Transmitted Light Detector 302 and each of the fluorescence detectors (571, 572, and 573). Each of the fluorescence detectors measures light at a unique range of wavelengths which can be used to measure fluorescence emissions in that wavelength range. In this embodiment a first fluorescence detector 571 measures fluorescent light from the fluorescently labeled detection antibody in the wavelength range from 560 nm to 580 nm in response to the first laser 327. A second fluorescence detector 572 measures fluorescence of the microspheres in the wavelength range of 660 nm to 680 nm in response to the second laser 429 and a third fluorescence detector 572 measures fluorescence of the microspheres in the wavelength range higher than 700 nm in response to the second laser 429.

The transmitted light image measures absorption and/or scattering of light at the wavelength of the first laser 327.

(8m) The transmitted light image is segmented to identify particles in the image and to measure information such as size and shape of each image. The output of the segmentation step is a list of particles identified in the image, X and Y coordinates of the centroid of each particle, a boundary of the pixels contained within the particle such as a bitmap, and may also include a size parameter such as the number of pixels contained within the boundary of the particle and/or a measure of shape such as ellipticity.

(8n) A transmitted light intensity value is calculated for each particle in the transmitted light image by calculating: 1) an estimate of the average intensity of the transmitted light image in the vicinity of the particle for pixels that are not within the boundary of that particle or of any other particle; 2) subtracting the average intensity value from the intensity value of each pixel contained within the boundary of the particle to obtained a background-subtracted intensity value for that pixel; 3) summing the background-subtracted intensity values for all pixels contained within the boundary of the particle; and 4) multiplying the pixel sum by −1(because the intensity value of pixels within the particle is typically lower than pixels not contained within a particle in the transmitted light image).

For each particle, a fluorescence intensity value for each fluorescence image (derived from fluorescence detectors 571, 572, and 573) is obtained by calculating: 1) an estimate of the average intensity of the fluorescence image in the vicinity of the particle for pixels that are not part of that particle or of any other particle; 2) subtracting the average intensity value from the intensity value of each pixel contained within the boundary of the particle to obtained a background-subtracted intensity value for that pixel; and 3) summing the background-subtracted intensity values for all pixels contained within the boundary of the particle. The location of the particle and the boundary of the particle found from segmenting the transmitted light image are used for the calculation of each fluorescence intensity value.

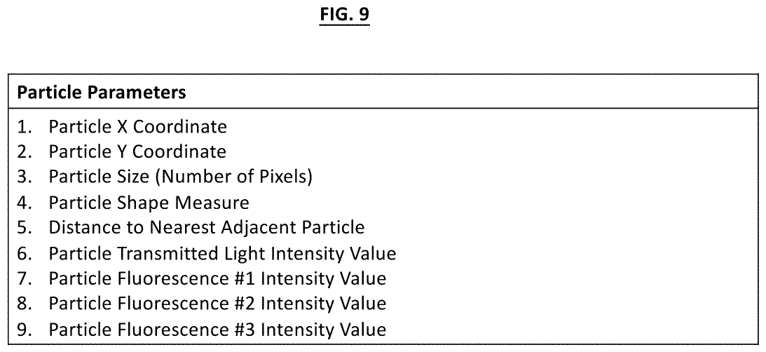

The result of the image analysis described above is a record of each particle containing all of the parameters listed in FIG. 9.

(8o) A subset of the parameters listed in FIG. 9 may be used to confirm the identity of particles that are likely to be microspheres and to further identify particles that are not likely to be microspheres. A subset of the particles which have been identified as microspheres may be created for subsequent analysis. For example, particles may be excluded from subsequent analysis if they are 1) too small; 2) too large; or 3) too close to adjacent particles.

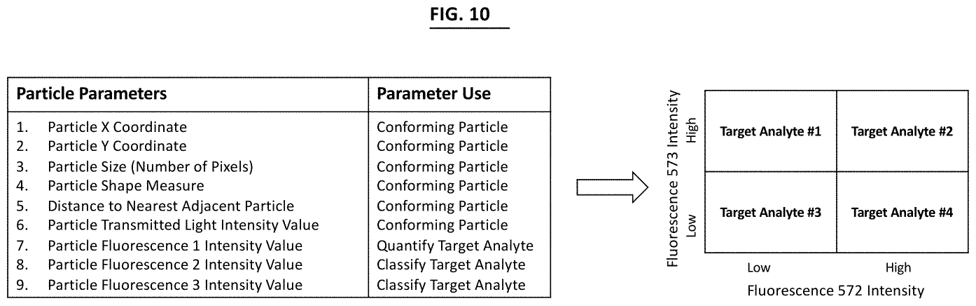

(8p) Fluorescence intensities determined from fluorescence detector 572 and fluorescence detector 573 are used to identify microspheres belonging to each of the different populations, each of which population is specific to one of the 4 target analytes. FIG. 10 illustrates one such classification scheme, where low and high values of Fluorescence Intensities 2 and 3 are used to classify microspheres into 4 different populations.

It will be appreciated that fewer or more than 2 colors of fluorescence may be used to classify microspheres and fewer or more than 2 intensity levels of each fluorescence color may be used, resulting in a large number of different populations that can be classified using this method.

It will be further appreciated that a benefit of this method is its ability to use parameters other than fluorescence intensity to classify particles. Other classification schemes could use particle size, particle shape measures (such as ellipticity), particle granularity, or opacity at wavelengths other than the wavelength used to excite the fluorescent label.

(8q) A measure of the average fluorescence intensity for all the particles included in the subset of particles identified as each population of microspheres is calculated, such as the median fluorescence intensity.

(8r) The average fluorescence intensity is then used to calculate the concentration in the sample of the target analyte to which that population of microspheres selectively binds. This concentration is calculated using a standard curve as illustrated in FIG. 7 and as described in this method.

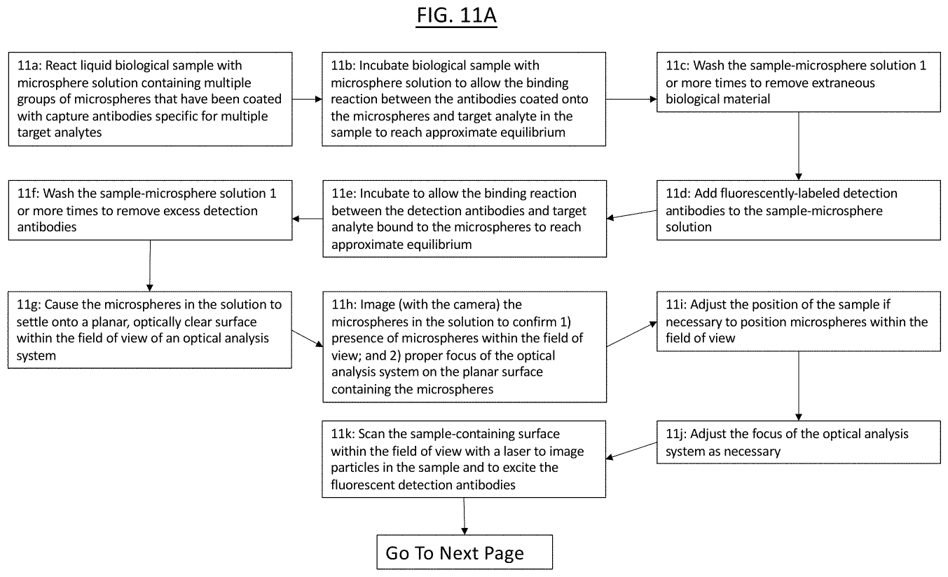

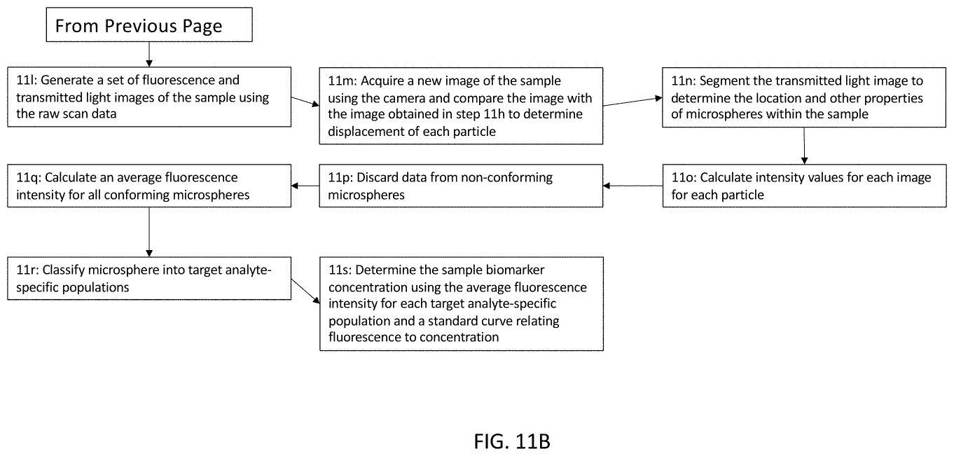

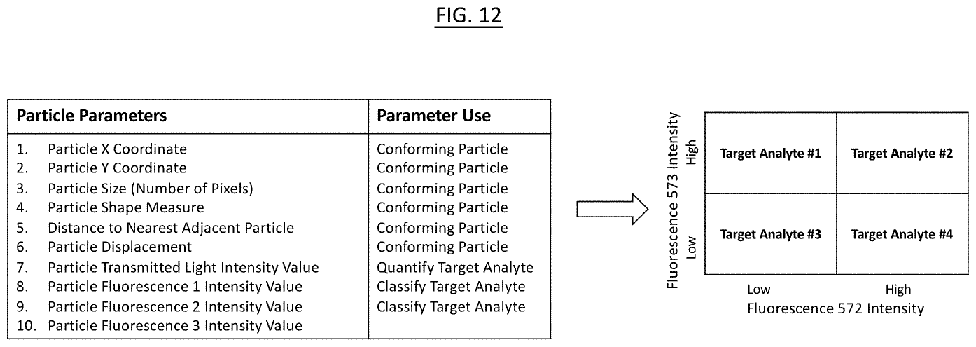

An additional embodiment of this method is illustrated in FIG. 11. FIG. 11 depicts a method identical to the method described in FIG. 8 but with the addition of a second image made of the sample using the Illumination Source 301 and Camera 322. The second image is generated after the sample is scanned using the laser-scanning confocal system, and the images taken before and after the scan are compared to determine the displacement (if any) of each particle during the scan (11k). The displacement of each particle during the scan can then be used as an additional criterion to exclude particles from subsequent analysis, resulting in the extended list of parameters shown in FIG. 12.

This specification is to be construed as illustrative only and is for the purpose of teaching those skilled in the art the manner of carrying out the disclosure. It is to be understood that the forms of the disclosure herein shown and described are to be taken as the presently preferred embodiments. As already stated, various changes may be made in the shape, size and arrangement of components or adjustments made in the steps of the method without departing from the scope of this disclosure. For example, equivalent elements may be substituted for those illustrated and described herein and certain features of the disclosure maybe utilized independently of the use of other features, all as would be apparent to one skilled in the art after having the benefit of this description of the disclosure.

While specific embodiments have been illustrated and described, numerous modifications are possible without departing from the spirit of the disclosure, and the scope of protection is only limited by the scope of the accompanying claims.

What I claim is:

1. A method for enhanced speed and efficacy in imaging samples using scanning cytometry comprising:
(a) Using a first illumination source to illuminate a sample;
(b) Utilizing an objective lens to create an image of the illuminated sample with a camera;
(c) Evaluating the image for presence, focus or positioning of particles within the sample
(d) Depending upon the evaluation of samples either reposition the objective lens relative to the sample or create an image utilizing one or more lasers.
